(19) United States
(12) Patent Application Publication
(10) Pub. No.: US 2025/0310905 A1
(43) Pub. Date: Oct. 2, 2025

(54) TERMINAL, BASE STATION AND COMMUNICATION METHOD

(71) Applicant: NTT DOCOMO, INC., Tokyo (JP)

(72) Inventors: Mayuko Okano, Chiyoda-ku, Tokyo (JP); Hiroki Harada, Chiyoda-ku, Tokyo (JP); Shinya Kumagai, Chiyoda-ku, Tokyo (JP); Daisuke Kurita, Chiyoda-ku, Tokyo (JP); Tomoya Ohara, Chiyoda-ku, Tokyo (JP); Masaya Okamura, Chiyoda-ku, Tokyo (JP); Kousuke Shima, Chiyoda-ku, Tokyo (JP)

(73) Assignee: NTT DOCOMO, INC., Tokyo (JP)

(21) Appl. No.: 18/855,755

(22) PCT Filed: Apr. 18, 2022
(86) PCT No.: PCT/JP2022/018095

§ 371 Date: Oct. 10, 2024

(51) Int. Cl. H04W 56/00; H04L 1/00; H04W 72/044

(52) U.S. Cl. CPC H04W 56/0015; H04L 1/0068; H04W 72/044

(57) ABSTRACT

A terminal includes a receiving unit configured to receive a synchronization signal or a broadcast signal, and a controller configured to assume that receiving the synchronization signal or the broadcast signal is based on individual configurations for a terminal with reduced functions.

### TECHNICAL FIELD

The disclosures herein relate to terminals, base stations and communication methods in a wireless communication system.

### BACKGROUND ART

In NR (New Radio) (also referred to as “5G”), which is a successor system to LTE (Long Term Evolution), as requirements, a technology to satisfy a large-capacity system, a high-speed data transmission rate, a low delay, simultaneous connection of a large number of terminals, a low cost, power saving and the like is being considered (e.g., Non-Patent Literature 1).

In LTE or NR, a UE category or UE capability for the Internet of Things (IoT) is defined in which functions mandatorily supported by a normal terminal are reduced, for example, a function related to transmission and reception bandwidth and the number of antennas. For example, eMTC (Enhanced Machine Type Communication) and NB-IoT (Narrow Band IoT) are defined in LTE, and a RedCap (Reduced Capability) is defined in NR.

In addition, consideration has started on advanced systems beyond 5G, or 6G. Further improvement of communication performance and diversification of use cases are assumed in such advanced systems.

### CITATION LIST

### Non-Patent Literature

[Non-patent literature 1]3GPP TS 38.300 V16.8.0 (2021-12)

### SUMMARY OF THE INVENTION

### Problem to be Solved by the Invention

In an advanced system (e.g., 6G, which is a successor of NR Release 18 and NR), an eRedCap (enhanced Reduced Capability), which is further reduced in functions than the RedCap, which is considered in NR release 17, has been considered. However, conventionally, it has not been clear how the eRedCap receives a synchronization signal or a broadcast signal.

The present invention has been made in view of the above-mentioned point, and it is an object of the present invention to appropriately receive the synchronization signal or the broadcast signal by a terminal with reduced functions in a wireless communication system.

### Means of Solving the Problem

According to the disclosed technology, a terminal includes a receiving unit configured to receive a synchronization signal or a broadcast signal, and a controller configured to assume that receiving the synchronization signal or the broadcast signal is based on individual configurations for a terminal with reduced functions.

### Effects of the Invention

According to the disclosed technology, a technology to enable the terminal with reduced functions to appropriately receive the synchronization signal or the broadcast signal is provided.

### BRIEF DESCRIPTION OF THE DRAWINGS

FIG. 1 is a drawing describing a wireless communication system according to an embodiment of the present invention.

FIG. 2 is a drawing describing a conventional method of receiving a synchronization signal.

FIG. 3 is a drawing illustrating an example of a bandwidth of a conventional synchronization signal and a broadcast signal.

FIG. 4 is a drawing describing a method of receiving an SSB according to a second example of the embodiment of the present invention.

FIG. 5 is a drawing describing a method of receiving the broadcast signal according to option 1 of a third example of the embodiment of the present invention.

FIG. 6 is a drawing describing a method of receiving the broadcast signal according to option 2 of the third example of the embodiment of the present invention.

FIG. 7 is a drawing describing a specification of time and frequency resources of the broadcast signal according to example 4 of the embodiment of the present invention.

FIG. 8 is a drawing illustrating an example of a functional configuration of a base station according to the embodiment of the present invention.

FIG. 9 is a drawing illustrating an example of a functional configuration of a terminal according to the embodiment of the present invention.

FIG. 10 is a drawing illustrating an example of a hardware configuration of a base station or a terminal according to the embodiment of the present invention.

FIG. 11 is a drawing illustrating an example of a configuration of a vehicle according to the embodiment of the present invention.

### DESCRIPTION OF THE PREFERRED EMBODIMENTS

In the following, an embodiment of the present invention will be described with reference to the accompanying drawings. The embodiment described below is only an example, and the embodiment to which the present invention is applied is not limited to the following embodiment.

In an operation of a wireless communication system of the embodiment of the present invention, the existing technology is used as appropriate. However, the existing technology is, for example, the existing LTE, but is not limited to the existing LTE. A term “LTE” used in the present specification has a broad meaning including LTE-Advanced and later systems (e.g., NR) than LTE-Advanced unless otherwise specified.

In the embodiment of the present invention described below, terms such as SS (Synchronization signal), PSS (Primary SS), SSS (Secondary SS), PBCH (Physical Broadcast Channel), PRACH (Physical Random Access Channel), PDCCH (Physical Downlink Control Channel), PDSCH (Physical Downlink Shared Channel), PUCCH (Physical Uplink Control Channel), and PUSCH (Physical Uplink Shared Channel) used in existing LTE are used. This is for convenience of description, and signals and functions similar to these may be referred to as other names. The above terms in NR correspond to NR-SS, NR-PSS, NR-SSS, NR-PBCH, NR-PRACH, and the like. However, even signals used in NR are not necessarily referred to as “NR-”.

In the embodiment of the present invention, a duplex system may be a TDD (Time Division Duplex) system, an FDD (Frequency Division Duplex) system, or any other (e.g., Flexible Duplex, etc.) system.

In the embodiment of the present invention, to “configure” wireless parameters and the like may mean that predetermined values are pre-configured, or that the wireless parameters notified from a base station 10 or a terminal 20 are configured.

### (System Configuration)

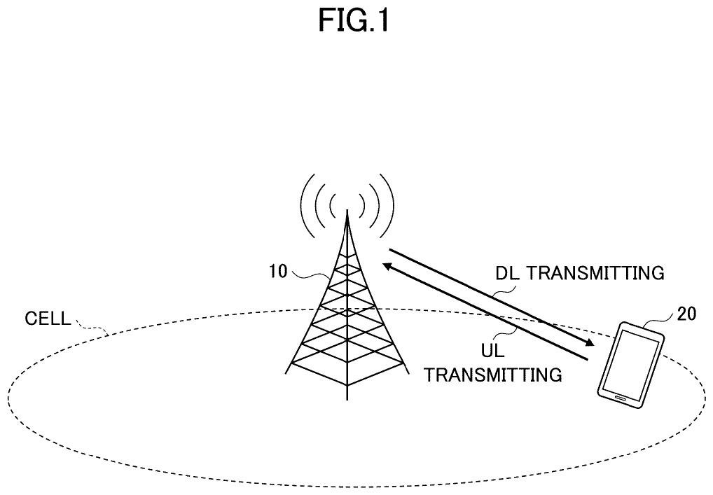

FIG. 1 is a drawing describing the wireless communication system according to the embodiment of the present invention. As shown in FIG. 1, the wireless communication system according to the embodiment of the present invention includes the base station 10 and the terminal 20. Although one base station 10 and one terminal 20 are shown in FIG. 1, these are examples and a plurality of each may be used.

The base station 10 is a communication device that provides one or more cells and performs wireless communication with the terminal 20. Physical resources of a wireless signal are defined in a time domain and a frequency domain, and the time domain may be defined by the number of OFDM (Orthogonal Frequency Division Multiplexing) symbols, and the frequency domain may be defined by the number of subcarriers or resource blocks. The TTI (Transmission Time Interval) in the time domain may be a slot, or the TTI may be a subframe.

The base station 10 transmits the synchronization signal and system information to the terminal 20. The synchronization signals are, for example, NR-PSS and NR-SSS. The system information is, for example, transmitted in NR-PBCH and is also referred to as broadcast information. The synchronization signal and system information may be referred to as SSB (SS/PBCH Block). As shown in FIG. 1, the base station 10 transmits control signals or data to the terminal 20 in DL (Downlink) and receives control signals or data from the terminal 20 in UL (Uplink). Both the base station 10 and the terminal 20 can transmit and receive signals by beamforming. Both the base station 10 and the terminal 20 can apply MIMO (Multiple Input Multiple Output) communication to DL or UL. Also, both the base station 10 and the terminal 20 may communicate via a secondary cell (SCell) and a primary cell (PCell) by CA (Carrier Aggregation). Further, the terminal 20 may perform communication via the primary cell of the base station 10 by DC (Dual Connectivity) and the primary secondary cell group cell (PSCell: Primary SCG Cell) of the other base station 10.

The terminal 20 is a communication device having a wireless communication function such as a smartphone, a mobile phone, a tablet, a wearable terminal, or a machine-to-machine (M2M) communication module. As shown in FIG. 1, the terminal 20 receives control signals or data from the base station 10 by DL and transmits control signals or data to the base station 10 by UL, thereby utilizing various communication services provided by the wireless communication system. The terminal 20 also receives various reference signals transmitted from the base station 10 and performs measurement of propagation path quality based on reception results of the reference signals. The terminal 20 may be referred to as UE and the base station 10 may be referred to as gNB.

### (RedCap of NR Release 17)

First, RedCap of conventional NR Release 17 will be described. A maximum bandwidth supported by RedCapUE considered in the NR Release 17 is 20 MHz for FR1 (Frequency Range 1) and 100 MHz for FR2 (Frequency Range 2). The RedCapUE is required to coexist with the non-RedCapUE (Hereinafter, it is also referred to as “non-RedCapUE”.) in the system.

The RedCapUE and the non-RedCapUE may also be able to share the same initial DL-BWP (Downlink Bandwidth Part) (including subcarrier spacing, bandwidth and position) set by the MIB (Master Information Block). Additionally, the initial DL-BWP may be configured with a separate or additional subcarrier interval, bandwidth and position for the RedCapUE.

The RedCapUE may share the initial DL-BWP (Hereinafter, it is also referred to as “DL-BWP #0”.) for the non-RedCapUE if it does not exceed the maximum bandwidth supported by the RedCapUE.

In addition, according to the NR Release 17 specification, the DL-BWP and UL-BWP of the same index are required to have the same center frequency in the case of TDD to avoid RF re-tuning.

Moreover, the RedCapUE assumes that the initial DL-BWP and the active DL-BWP become less than or equal to the maximum DL bandwidth supported by the RedCapUE after (re)establishing a dedicated RRC connection. The RedCapUE is provided with DL-BWP by “initialDownlinkBWP” in “DownlinkConfigCommonRedCapSIB” and UL-BWP by “initialUplinkBWP” in “UplinkConfigCommonRedCapSIB”. When “initialUplinkBWP” of “UplinkConfigCommonSIB” shows a UL-BWP greater than the maximum UL-BWP supported by the RedCapUE, the RedCapUE assumes that the UL-BWP is provided by “initialUplinkBWP” of “UplinkConfigCommonRedCapSIB”.

The RedCapUE may be provided with DL-BWP by “BWP-DownlinkDedicated” in addition to initial DL-BWP. The RedCapUE may be provided with UL-BWP by “BWP-UplinkDedicated” in addition to initial UL-BWP less than or equal to the maximum UL bandwidth supported by the RedCapUE.

When the RedCapUE is provided with “RACH-ConfigCommon-RedCap” or “RACH-ConfigCommonTwoStepRA-RedCap”, the RedCapUE performs initial access and random access procedures using the corresponding parameters. Otherwise, RedCapUE uses the corresponding parameters provided by “RACH-ConfigCommon” or “RACH-ConfigCommonTwoStepRA”.

The RedCapUE is provided with “initialUplinkBWP” of “UplinkConfigCommonRedCapSIB” and sends PUCCH with HARQ-ACK information using PUCCH resource set provided by “pucch-ResourceCommonRedCap” if there is no dedicated PUCCH resource configuration. Note that when “disable-FH-PUCCH” is provided in “PUCCH-ConfigCommonRedCap”, PUCCH transmission is disabled.

For an initial DL-BWP provided by “initialDownlinkBWP” of “DownlinkConfigCommonRedCapSIB”, the RedCapUE recognizes that the initial DL-BWP does not contain an SS/PBCH block or a CORESET with index 0 if it observes PDCCH according to the CSS set of Type1-PDCCH and does not observe PDCCH according to the CSS set of Type2-PDCCH.

The RedCapUE assumes that when PDCCH is observed according to the CSS set of Type2-PDCCH, when the RedCapUE acquires SIB1 using an SS/PBCH block, an SS/PBCH block and a CORESET of the index 0 are included in the initial DL-BWP, and when the SS/PBCH block is included, and the SS/PBCH block used by the RedCapUE to acquire SIB1 is not included in the initial DL-BWP, the CORESET of the index 0 is not included.

In case of an active DL-BWP provided by “BWP-DownlinkDedicated”, the RedCapUE assumes that the SS/PBCH block is included and the CORESET with the index 0 is not included in the active DL-BWP, except a function operating in the DL-BWP without receiving an SS/PBCH block is shown.

### (RedCap of NR Release 18)

The consideration status of the RedCap of NR Release 18 is described below. In the NR release 18, eRedCap is being considered to further reduce the complexity of the RedCapUE for NR release 17. Hereinafter, a terminal with reduced functions for NR release 17 is referred to as a RedCapUE, and an extended terminal with reduced functions for NR release 18 is referred to as an eRedCapUE. A RedCapUE is an example of a first terminal with reduced functions. An eRedCapUE is an example of a second terminal with reduced functions. That is, the first terminal with reduced functions is a terminal with a reduced first function, and the second terminal with reduced functions is a terminal with a reduced second function that is different from (or partially overlapping with) the first function.

An effect to the network, coexistence of RedCapUE or eRedCapUE with non-RedCapUE in a cell, an effect to the UE, an effect to the specification, etc. are considered. Potential solutions that may complement each other to reduce device complexity focus on below.

The first solution is considered to reduce the UE bandwidth to 5 MHz in FR1. This solution may be specified in combination with relaxed UE processing timelines of PDSCH and/or PUSCH and/or CSI.

The second solution is to reduce the UE peak data rate of FR1. This solution may include limited bandwidth of PDSCH and/or PUSCH and may be specified in combination with relaxed UE processing timelines of PDSCH and/or PUSCH and/or CSI.

It is considered that the following is required to be aware of the following in the eRedCapUE. That is, SSB specified in NR Release 15 is required to be reused to minimize the change of L1. Further, BWP behavior with or without SSB, and with or without RF Retuning are required to be considered. Furthermore, it is considered that some solutions of FR1 can be applied to FR2. Moreover, defining a type of reduced-functionality terminal for a single Release 18 is considered in order to further reduce the complexity of UE.

Next, reception of the synchronization signal in the NR release 15 will be described with reference to the drawings.

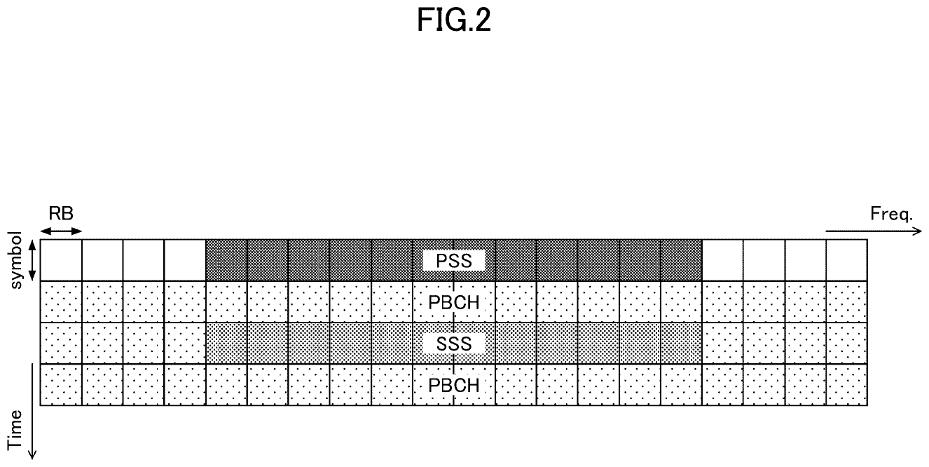

FIG. 2 is a drawing describing a conventional method of receiving a synchronization signal. Conventionally, the SSB (SS/PBCH block) to receive the synchronization signal (PSS, SSS) and the broadcast signal (PBCH) is configured as shown in FIG. 2.

Among them, information reported by the PBCH (56 bits) is as shown in 1) and 2) below.

1) Information (MIB) generated in the upper layer MSB (Most Significant Bit) of the SFN (System Frame Number): 6 bits
subcarrier offset: 4 bits
prohibited cells: 1 bit
cell re-selection: 1 bit
SCS of RMSI (Remaining Minimum System Information): 1 bit
DMRS (DeModulation Reference Signal) type of PDSCH: 1 bit
PDCCH configuration of RMSI: 8 bits
reserved: 2 bits
2) Information generated in the physical layer SFN Least Significant Bit (LSB): 4 bits
Half Frame Index: 1 bit
SSB Index MSB: 3 bits
CRC (Cyclic Redundancy Check): 24 bits

### (Conventional Problem)

As described above, the eRedCapUE for NR release 18 is under consideration.

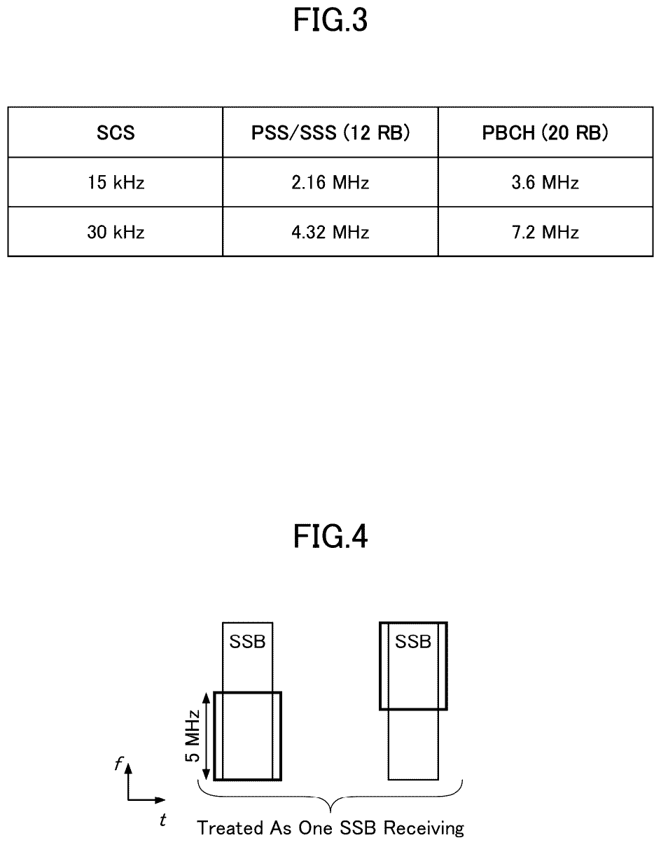

FIG. 3 is a drawing illustrating an example of a bandwidth of a conventional synchronization signal and a broadcast signal. In the conventional specification, when SCS is 30 kHz, the bandwidth of PBCH exceeds 5 MHz. Therefore, when the maximum bandwidth of the eRedCapUE is 5 MHz, there is a problem that the eRedCapUE cannot properly receive PBCH.

### Outline of the Present Embodiment

Therefore, in the present embodiment, a PBCH reception method of an eRedCapUE will be described. Examples 1 to 5 will be described below. The terminal 20 of each embodiment is assumed to be an eRedCapUE unless otherwise specified.

First, definitions of a RedCapUE, an eRedCapUE, and a non-RedCapUE will be described.

The definition of RedCapUE may be any of 1)-3) below, or any other definition.

1) A UE that has notified the network that its own device is a RedCapUE in any of Msg. 1, 3, or A. For example, Msg. 1 or A may be transmitted by a resource defined or configured for RedCapUE, or a notification field in Msg3 specified or configured for RedCapUE may be used to notify that the apparatus is a RedCapUE.

2) A UE that supports a specific UE capability. For example, the specific UE capability may be a UE capability that supports a maximum 20 MHz bandwidth in FR1 and a maximum 100 MHz bandwidth in FR2. The specific UE capability may also be a UE capability that supports one or two receiving branches and a UE capability that supports a maximum number of DL-MIMO layers corresponding to the number of receiving branches. The specific UE capability may also be a UE capability that supports either FD-FDD (Full Duplex-Frequency Division Duplex) or Type A HD-FDD (Half Duplex-Frequency Division Duplex) operation in the FDD band of FR1. The specific UE capability may also be a UE capability that supports either DL up to 64 QAM (Quadrature Amplitude Modulation) or DL up to 256 QAM in FR1. The specific UE capability may also be a UE capability that does not support CA and/or DC.

3) A UE that has reported to the network that it supports a specific UE capability shown in 2) above.

The definition of eRedCapUE may be any of the following 1)-3) or any other definition.

1) A UE that has notified the network that its device is an eRedCapUE in any of Msg. 1, 3, or A. For example, Msg. 1 or A may be transmitted by a resource defined or configured for the eRedCapUE, or a notification field in Msg3 defined or configured for the eRedCapUE may be used to notify the network that its device is the eRedCapUE.

2) A UE that supports a specific UE capability. For example, the specific UE capability may be a UE capability to support up to 5 MHz bandwidth at FR1. The specific UE capability may also be a UE capability to support PDSCH and/or PUSCH and/or CSI relaxed UE processing timelines. The specific UE capability may also be a UE capability to support reduced UE peak data rates at FR1. The specific UE capability may also be a UE capability to support one or two receiving branches and a UE capability to support a maximum number of DL-MIMO layers corresponding to the number of receiving branches. The specific UE capability may also be a UE capability to support either FD-FDD (Full Duplex-Frequency Division Duplex) or Type A HD-FDD (Half Duplex-Frequency Division Duplex) operation in the FDD band at FR1. The specific UE capability may also be a UE capability to support either DL up to 64QAM (Quadrature Amplitude Modulation) or DL up to 256QAM at FR1. The specific UE capability may also be a UE capability that does not support CA and/or DC.

3) A UE that has reported to the network that it supports the specific UE capability shown in 2) above.

Moreover, the terminal 20 may report a UE capability indicating whether or not it supports a function shown in each embodiment described later. For example, the terminal 20 may report a UE capability indicating whether or not it supports a non-RedCapUE or a function using an initial DL and UL-BWP different from the RedCapUE. Further, the UE reporting that it supports the function may be an eRedCapUE, or the eRedCapUE may support the function as an option.

Moreover, the definition of a non-RedCapUE may be a UE that does not apply to either the definition of the RedCapUE or the definition of the eRedCapUE, a UE that supports a function that a normal UE supports mandatorily, or a UE that supports a bandwidth exceeding the maximum bandwidth supported by RedCapUE.

Moreover, the SSB/PBCH/PBCH-DMRS in the present embodiment may be an SSB/PBCH/PBCH-DMRS transmitted individually to the eRedCapUE, or an SSB/PBCH/PBCH-DMRS shared with the non-RedCapUE or RedCapUE.

### Example 1

In the present example, an example will be described in which the eRedCapUE does not receive the SSB of 30 kHz SCS.

The terminal 20 may assume that the specification specifies that only the SSB of 15 kHz SCS is transmitted. That is, the terminal 20 may assume that the specification specifies that the SSB of 30 kHz SCS is not transmitted.

The terminal 20 may interpret that the eRedCapUE is not allowed to be contained in a cell whose SSB SCS is 30 kHz SCS.

According to the present example, the SSB can be properly received by assuming that the eRedCapUE does not receive the SSB of 30 kHz SCS.

### Embodiment 2

In the present example, an example will be described in which the eRedCapUE receives the SSB divided into multiple times.

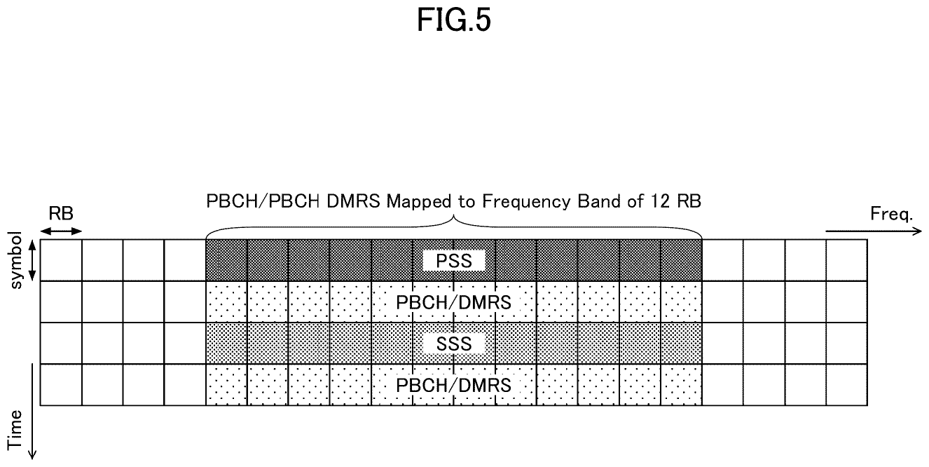

FIG. 4 is a drawing describing a method of receiving an SSB according to a second example of the present embodiment. The terminal 20 may assume to be specified to receive the SSB/PBCH/PBCH-DMRS a plurality of times.

For example, the terminal 20 may receive SSBs with different frequency and time resources respectively for two SSBs having the same ID, and combine them in the terminal 20 to treat them as one SSB receiving.

The base station 10 may transmit an SSB having the same ID multiple times within a single SSB burst set and/or within an SSB cycle in the case of a cell containing the eRedCapUE (including a case where a part of the terminals 20 contained therein are eRedCapUE terminals).

According to the present example, the SSB can be properly received by the eRedCapUE receiving the SSB a plurality of times.

### Example 3

In the present example, an example will be described in which the eRedCapUE receives PBCH within the maximum bandwidth due to puncture.

When the SCS of the SSB is 30 kHz SCS, the terminal 20 may receive the partially punctured PBCH/PBCH-DMRS with the maximum bandwidth of the eRedCap (e.g., 5 MHz).

Specifically, the terminal 20 may perform any of the following options.

### <Option 1>

The terminal 20 may assume that the PBCH punctured by the base station 10 is mapped to be within the maximum bandwidth resource of the eRedCap for the eRedCapUE.

FIG. 5 is a drawing describing a method of receiving a broadcast signal according to option 1 of a third example of the present embodiment. The terminal 20 may assume that the PBCH is mapped to a frequency resource of 12 RB so that the PBCH punctured by the base station 10 is within a 5 MHz resource for the eRedCapUE.

In Option 1, the base station 10 may puncture and transmit the PBCH for eRedCapUE so that the PBCH is within a resource of the maximum bandwidth of eRedCap for eRedCapUE, and may transmit the PBCH for RedCapUE or non-RedCapUE without puncturing.

### <Option 2>

The terminal 20 may puncture and receive a part of the PBCH resource.

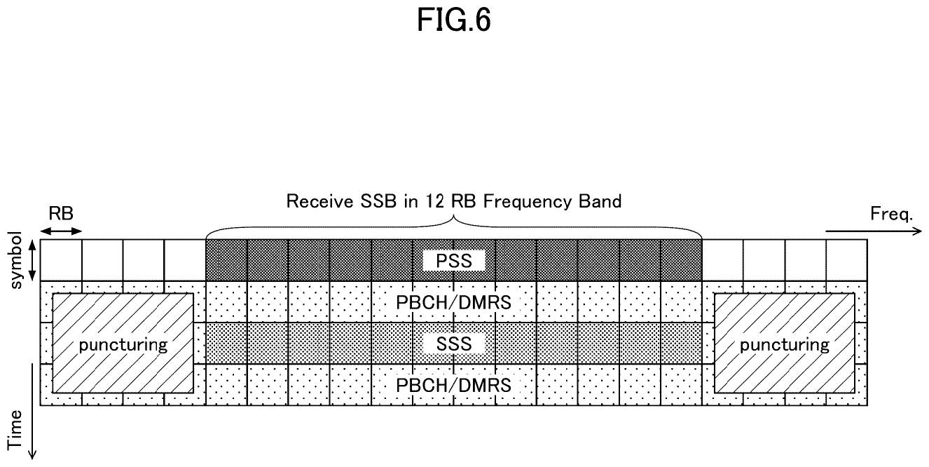

FIG. 6 is a drawing describing a method of receiving a broadcast signal according to option 2 of a third example of the present embodiment. The terminal 20 may puncture and receive a 12 RB frequency resource so that the PBCH is contained in a 5 MHz resource.

In either option, the terminal 20 may assume that the unit of the resource to be punctured is an RB or RE.

For example, when the SCS is 30 kHz, the terminal 20 may assume that the PBCH/PBCH-DMRS frequency direction resource is mapped to 12 RB or 13 RB.

Moreover, when the SCS is 30 kHz, the terminal 20 may only receive 12 RB or 13 RB for the PBCH/PBCH-DMRS frequency direction resource.

Moreover, when the SCS is 30 kHz, the terminal 20 may assume that the PBCH/PBCH-DMRS frequency direction resource is mapped to 166 RE.

Moreover, when the SCS is 30 kHz, the terminal 20 may only receive 166 RE for the PBCH/PBCH-DMRS frequency direction resource.

The terminal 20 may receive the PBCH a plurality of times repeatedly, and may assume that the number of times to receive the PBCH repeatedly is specified. In this way, coverage degradation due to punctures can be compensated. For example, the terminal 20 may receive the SSB/PBCH/PBCH-DMRS at least 2 times for the SSB having the same index.

According to the present, the eRedCapUE can receive the PBCH within the maximum bandwidth due to punctures.

### Example 4

In the present example, an example will be described in which the time and frequency resources of the PBCH are newly defined for the eRedCapUE.

The terminal 20 may assume that PBCH/PBCH-DMRS time and frequency direction resources are newly defined for the eRedCapUE when the SSB SCS is 30 kHz.

The terminal 20 may assume that PBCH/PBCH-DMRS frequency direction resources are limited. For example, the terminal 20 may assume that PBCH/PBCH-DMRS frequency resources of the eRedCapUE are limited to 12 RB, 13 RB, 127 RE or the like.

The terminal 20 may assume that PBCH/PBCH-DMRS time direction resources are expanded. For example, the terminal 20 may assume that PBCH/PBCH-DMRS time direction resources are expanded to six or five symbols.

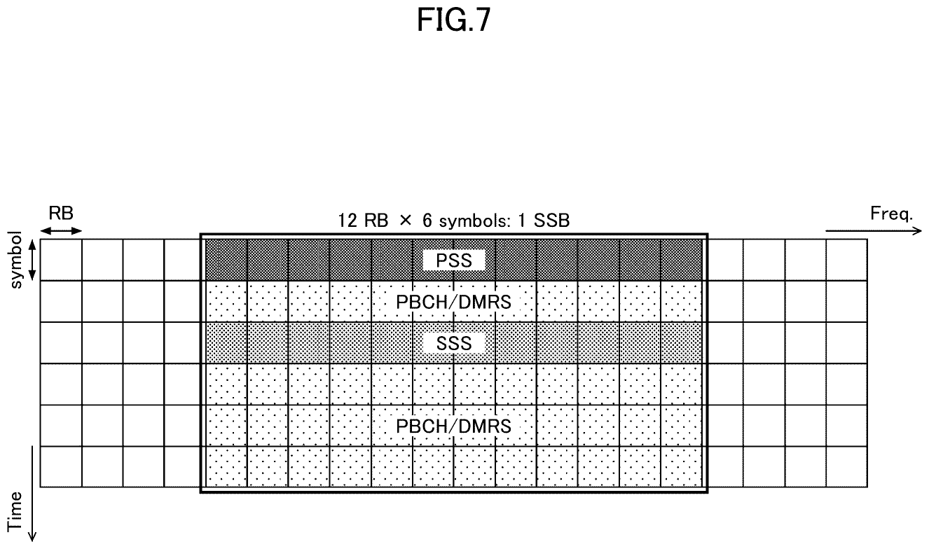

FIG. 7 is a drawing describing the specification of time and frequency resources of a broadcast signal according to example 4 of the present embodiment. The terminal 20 may assume that SSB frequency resources are limited to 12 RB and time direction resources are expanded to six symbols.

The base station 10 may transmit the PBCH/PBCH-DMRS for the eRedCapUE using a newly defined time or frequency resource, and may transmit the PBCH for the RedCapUE or non-RedCapUE using a conventional time or frequency resource.

The terminal 20 may repeatedly receive the PBCH a plurality of times, and may assume that the number of times of repeated reception is determined by the specification. This enables to compensate for the reduction in coverage due to resource reduction.

According to the present example, the eRedCapUE can appropriately receive the PBCH using a newly defined time or frequency resource.

### Example 5

In the present example, it may be assumed that the information to be notified by the PBCH is newly defined for the eRedCapUE.

The terminal 20 may assume that when the SCS of the SSB is 30 kHz, the information reported by the PBCH for the eRedCapUE is newly specified.

The information reported by the PBCH for the eRedCapUE may not include the information contained in the conventional MIB.

For example, the terminal 20 may assume that the configuration for “serachSpaceZero” and CORESET #0 for the eRedCapUE is specified in the specification, and may assume that the information reported by the PBCH for the eRedCapUE does not include “pdcch-configSIB1”.

The terminal 20 may assume that if the SCS of the SSB is 30 kHz, the “subCarrierSpacingCommon” (SIB1, Msg2 or Msg4 for initial access, paging, SCS for SI message broadcast) is specified such that the 15 kHz SCS is always applied to the eRedCapUE, and may assume that the information reported by the PBCH for the eRedCapUE does not include “subCarrierSpacingCommon”.

The terminal 20 may assume that when the SCS of the SSB is 30 kHz, either pos2 or pos3 always being applied to the eRedCapUE is specified in the specification, and may assume that the information reported by the PBCH for the eRedCapUE does not include “dmrs-TypeA-position”.

By reducing the number of bits in a trade-off with configuration flexibility, it is possible to reduce the coding rate and suppress the coverage decrease in the case of a puncture, and to transmit at a coding rate closer to that of the existing PBCH with fewer resources.

The information notified by the PBCH for the eRedCapUE may include information not included in the conventional MIB.

For example, the terminal 20 may assume that the number of receiving antennas of the eRedCapUE assumed by the base station 10 is included in the information notified by the PBCH for the eRedCapUE.

The terminal 20 may also assume that the configuration of the CSS of the CORESET #0 resource and type0-PDCCH for the eRedCapUE is notified separately from the resources for the RedCapUE or non-RedCapUE.

The terminal 20 may also assume that reserved bits are used in the information notified by the PBCH for the eRedCapUE.

According to the present example, the amount of information in the PBCH can be set to an appropriate amount by newly defining the information to be notified in the PBCH.

In the SSB for eRedCapUE and the SSB for RedCapUE or non-RedCapUE according to the present embodiment, the configuration (transmission period, frequency position, physical cell ID, PBCH-DMRS mapping, transmission power, SSB Index, etc.) related to the SSB reception may be the same or different. For example, the terminal 20 may assume that the transmission period of the SSB for eRedCapUE is shorter than the transmission period of the SSB for RedCapUE or non-RedCapUE.

The terminal 20 may assume that the SSB for the eRedCapUE is configured by RRC signaling individually, or that the SSB for eRedCapUE is notified by SIB1 associated with the SSB for eRedCapUE. The terminal 20 may assume that the physical cell ID is notified by PSS/SSS. For example, for “ssb-periodicityServingCell” included in “ServingCellConfigCommon” or “ServingCellConfigCommonSIB”, the terminal 20 may assume that the value for the eRedCapUE and the value for the RedCapUE or non-RedCapUE are configured independently.

The terminal 20 may assume that the SSB for the eRedCapUE and the SSB for the RedCapUE or non-RedCapUE according to the present embodiment have a QCL relation.

The terminal 20 may assume that the configuration contents of “pdcchConfigSIB1” reported in the MIB are the same or different between the SSB for eRedCapUE and the SSB for the RedCapUE or non-RedCapUE according to the present embodiment.

The terminal 20 may assume that the sync raster is the same or different between the SSB for eRedCapUE and the SSB for the RedCapUE or non-RedCapUE according to the present embodiment.

The case where the PBCH design or the SSB reception method according to the present embodiment is applied may be limited to any one or more of the following cases (different examples or options may be applied according to the following scenarios).
Serving cell, non-serving cell
The connection state of the RRC is idle, inactive, or connected mode.
The purpose of the SSB reception is RRM (Radio Resource Management), RLM (Radio Link Monitoring), BFD (Beam Failure Detection), Link Recovery, RO Selection, Mobility, Time or Frequency Tracking, AGC (Automatic Gain Control).

Moreover, the terminal 20 may assume that different examples or options are applied depending on whether the SSB is a CD-SSB (cell defined-SSB) (SSB for non-RedCapUE where the corresponding SIB1 exists) or an NCD-SSB (non cell defined-SSB) (SSB for eRedCapUE).

When the PBCH mapping or SSB reception method according to the present embodiment is applied, the terminal 20 may assume that the SSB is a QCL source for another downlink channel and signal, and may assume that it is not set as a QCL source.

When the PBCH mapping or SSB reception method according to the present embodiment is applied, the terminal 20 may assume that a special relation between the SSB and the uplink channel and signal is defined, or that it is not set as a special relation.

The terminal 20 may perform an operation in which a plurality of options according to the present embodiment are combined.

### (Device Configuration)

Next, an example of the functional configuration of the base station 10 and the terminal 20 that execute the processes and operations described so far will be described.

### <Base Station 10>

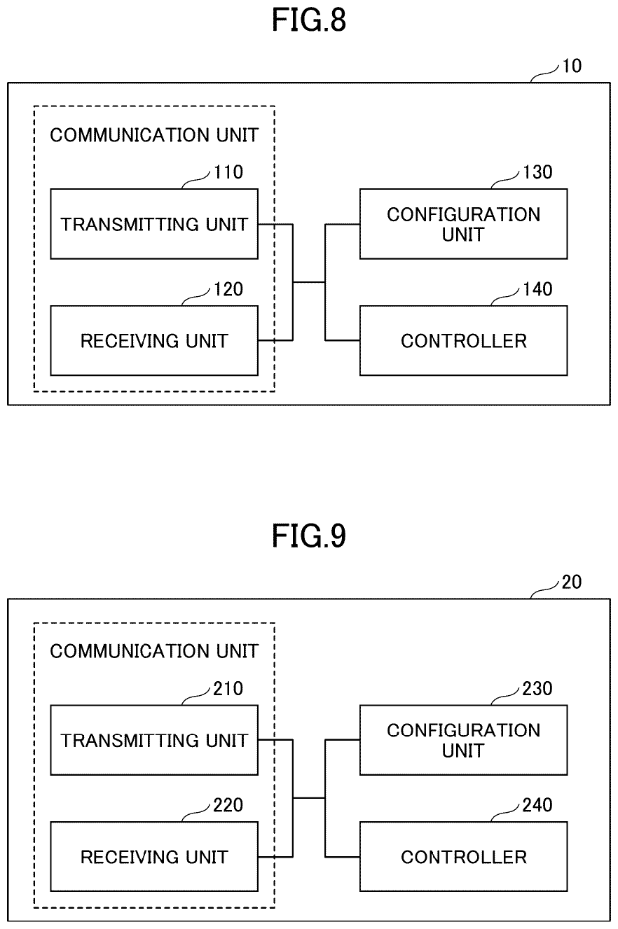

FIG. 8 is a drawing illustrating an example of a functional configuration of a base station 10. As shown in FIG. 8, the base station 10 includes a transmitting unit 110, a receiving unit 120, a configuration unit 130, and a controller 140. The functional configuration shown in FIG. 8 is merely an example. As long as the operation according to the embodiment of the present invention can be performed, the functional categories and names of the functional units may be any. The transmitting unit 110 and the receiving unit 120 may be collectively referred to as a communication unit.

The transmitting unit 110 includes a function of generating a signal to be transmitted to the terminal 20 and transmitting the signal wirelessly. The receiving unit 120 includes a function of receiving various signals transmitted from the terminal 20 and acquiring, for example, information of a higher layer from the received signal. The transmitting unit 110 also has a function of transmitting, to the terminal 20, NR-PSS, NR-SSS, NR-PBCH, DL and UL control signals, DCI by PDCCH, data by PDSCH, and the like.

The configuration unit 130 stores preset configuration information and various configuration information to be transmitted to the terminal 20 in a storage device provided in the configuration unit 130, and reads them from the storage device as necessary.

The controller 140 performs scheduling of DL reception or UL transmission by the terminal 20 via the transmitting unit 110. The controller 140 also includes a function of performing LBT. The transmitting unit 110 may include a function relating to signal transmission by the controller 140, and the receiving unit 120 may include a function relating to signal reception by the controller 140. The transmitting unit 110 may be referred to as a transmitter, and the receiving unit 120 may be referred to as a receiver.

### <Terminal 20>

FIG. 9 is a drawing illustrating an example of a functional configuration of the terminal 20. As shown in FIG. 9, the terminal 20 includes a transmitting unit 210, a receiving unit 220, a configuration unit 230, and a controller 240. The functional configuration shown in FIG. 9 is only an example. As long as the operation according to the embodiment of the present invention can be executed, the functional categories and names of the functional units may be any. The transmitting unit 210 and the receiving unit 220 may be collectively referred to as a communication unit.

The transmitting unit 210 generates a transmission signal from the transmission data and transmits the transmission signal wirelessly. The receiving unit 220 receives various signals wirelessly and acquires a signal of a higher layer from the received physical layer signal. The receiving unit 220 has a function of receiving NR-PSS, NR-SSS, NR-PBCH, DL, UL, and SL control signals, DCI by PDCCH, and data by PDSCH transmitted from the base station 10. For example, the transmitting unit 210 may transmit PSCCH (Physical Sidelink Control Channel), PSSCH (Physical Sidelink Shared Channel), PSDCH (Physical Sidelink Discovery Channel), PSBCH (Physical Sidelink Broadcast Channel), etc. to the other terminal 20 as D2D communication, and the receiving unit 120 may receive PSCCH, PSSCH, PSDCH, PSBCH, etc. from the other terminal 20.

The configuration unit 230 stores various kinds of configuration information received from the base station 10 or the other terminal by the receiving unit 220 in the storage device of the configuration unit 230, and reads them from the storage device as necessary. The configuration unit 230 also stores preset configuration information. The controller 240 controls the terminal 20. The controller 240 includes a function of performing LBT.

The terminal of the present embodiment may be configured as a terminal shown in the following items. Further, the following communication method may be implemented.

### Configuration Concerning the Present Embodiment

(Article 1) A terminal including:
a receiving unit configured to receive a synchronization signal or a broadcast signal; and
a controller configured to assume that receiving the synchronization signal or the broadcast signal is based on individual configurations for a terminal with reduced functions.
   (Article 2) The terminal according to article 1, wherein the controller is configured to assume that the synchronization signal or the broadcast signal having a same index is received for a plurality of times.
   (Article 3) The terminal according to article 1 or 2, wherein the controller is configured to assume that a bandwidth of the synchronization signal or the broadcast signal exceeding a maximum bandwidth of the terminal with reduced functions has been punctured or assume that reception is performed by puncturing the bandwidth of the synchronization signal or the broadcast signal exceeding the maximum bandwidth of the terminal with reduced functions.
   (Article 4) The terminal according to any one of articles 1 to 3, wherein the controller is configured to assume that the synchronization signal or the broadcast signal is received at a time or frequency resource defined by the individual configurations.
   (Article 5) A base station including:
a transmitting unit configured to transmit a synchronization signal or a broadcast signal to a terminal; and
a controller configured to assume that the synchronization signal or the broadcast signal is received based on individual configurations for a terminal with reduced functions.
   (Article 6) A communication method performed by a terminal including:
receiving a synchronization signal or a broadcast signal; and
assuming that receiving the synchronization signal or the broadcast signal is based on individual configurations for a terminal with reduced functions.

Any of the above configurations provides a technique for enabling the terminal with reduced functions to appropriately receive the synchronization signal or the broadcast signal in a wireless communication system. According to article 1, it can be assumed that the terminal with reduced functions receives the synchronization signal or the broadcast signal based on individual configurations. According to article 2, it can receive the synchronization signal or the broadcast signal having the same index on multiple occasions. According to article 3, it can be assumed that the synchronization signal or the broadcast signal is punctured for a bandwidth exceeding the maximum bandwidth of the terminal with reduced functions, or it can be assumed that the synchronization signal or the broadcast signal is punctured for a bandwidth exceeding the maximum bandwidth of the terminal with reduced functions. According to article 4, it can be assumed that the synchronization signal or the broadcast signal is received at a time or frequency resource defined by individual configurations.

### (Hardware Configuration)

The block diagrams (FIGS. 8 and 9) used in the description of the above embodiment show blocks of functional units. These functional blocks (components) are implemented by any combination of at least one of hardware and software. The method of implementing each functional block is not particularly limited. That is, each functional block may be implemented using a single device that is physically or logically coupled, or may be implemented using a plurality of devices that are connected directly or indirectly (e.g., using wired, wireless, etc.) to two or more devices that are physically or logically separated. The functional block may be implemented by combining the one device or the plurality of devices with software.

The functions include, but are not limited to, determining, judgment, calculating, computing, processing, deriving, investigating, looking up (search, inquiry), ascertaining, receiving, transmitting, output, access, resolving, selecting, choosing, establishing, comparing, assuming, expecting, considering, broadcasting, notifying, communicating, forwarding, configuring, reconfiguring, allocating (mapping), and assigning. For example, the functional block (functional unit) that functions transmission is referred to as a transmitting unit or a transmitter. As described above, the implementation method is not particularly limited.

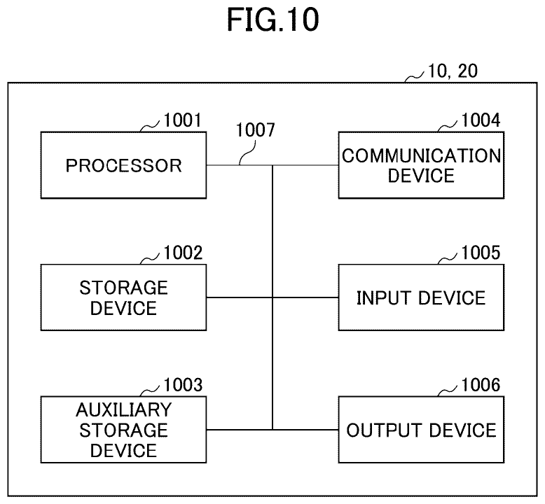

For example, the base station 10, the terminal 20, and the like in one embodiment of the present disclosure may function as computers that perform the processing of the wireless communication method of the present disclosure. FIG. 10 is a drawing showing an example of the hardware configuration of the base station 10 and the terminal 20 according to one embodiment of the present disclosure. Physically, the base station 10 and the terminal 20 may be configured as computer devices including a processor 1001, a storage device 1002, an auxiliary storage device 1003, a communication device 1004, an input device 1005, an output device 1006, a bus 1007, and the like.

In the following description, the term “device” may be replaced with a circuit, a device, a unit, and the like. The hardware configuration of the base station 10 and the terminal 20 may be configured to include one or more of the devices shown in the figure, or may be configured not to include some of the devices.

The functions of the base station 10 and the terminal 20 are achieved by reading predetermined software (programs) into hardware such as the processor 1001 and the storage device 1002, so that the processor 1001 performs calculations and controls communication by the communication device 1004, or controls at least one of reading and writing of data in the storage device 1002 and the auxiliary storage device 1003.

The processor 1001 controls the entire computer by operating an operating system, for example. The processor 1001 may include a central processing unit (CPU) including an interface with peripheral devices, a control device, an arithmetic unit, a register, and the like. For example, the controller 140, the controller 240, and the like may be implemented by the processor 1001.

The processor 1001 reads a program (program code), a software module, data, and the like from at least one of the auxiliary storage device 1003 and the communication device 1004 to the storage device 1002, and executes various processes in accordance with these. As the program, a program that causes the computer to execute at least a part of the operations described in the above-described embodiments is used. For example, the controller 140 of the base station 10 shown in FIG. 8 may be implemented by a control program stored in the storage device 1002 and operated by the processor 1001. For example, the controller 240 of the terminal 20 shown in FIG. 9 may be implemented by a control program stored in the storage device 1002 and operated by the processor 1001. Although the above-described various processes are executed by one processor 1001, they may be executed simultaneously or sequentially by two or more processors 1001. The processor 1001 may be implemented by one or more chips. The program may be transmitted from a network via a telecommunications line.

The storage device 1002 is a computer-readable recording medium, and may include, for example, at least one of ROM (Read Only Memory), EPROM (Erasable Programmable ROM), EEPROM (Electrically Erasable Programmable ROM), RAM (Random Access Memory), and the like. The storage device 1002 may be referred to as a register, a cache, a main memory, and the like. The storage device 1002 can store executable programs (program codes), software modules, and the like for implementing the communication method according to one embodiment of the present disclosure.

The auxiliary storage device 1003 is a computer-readable recording medium, and may include, for example, at least one of an optical disk such as CD-ROM (Compact Disc ROM), a hard disk drive, a flexible disk, a magneto-optical disk (e.g. compact discs, digital versatile discs, Blu-ray (registered trademark) discs), a smart card, a flash memory (e.g., cards, sticks, key drives), a floppy disk (registered trademark), a magnetic strip, and the like. The above-described storage medium may be, for example, a database including at least one of the storage device 1002 and the auxiliary storage device 1003, a server, or other suitable medium.

The communication device 1004 is a hardware (transmission and reception device) to communicate between computers via at least one of a wired network and a wireless network, and may also be referred to, for example, as a network device, a network controller, a network card, or a communication module. The communication device 1004 may include, for example, a high-frequency switch, a duplexer, a filter, a frequency synthesizer, and the like to achieve at least one of frequency division duplex (FDD) and time division duplex (TDD). For example, the transmitting and receiving antenna, the amplifier section, the transmitting and receiving section, the transmission line interface, and the like may be implemented by the communication device 1004. The transmitting and receiving section may be physically or logically separated from the transmitting section and the receiving section.

The input device 1005 is an input device (e.g., keyboard, mouse, microphone, switch, button, sensor, etc.) that receives an input from the outside. The output device 1006 is an output device (e.g., displays, speakers, LED lamps, etc.) that performs an output to the outside. The input device 1005 and the output device 1006 may be integrated (e.g., a touch panel).

The respective devices such as the processor 1001 and the storage device 1002 are connected by a bus 1007 for communicating information. The bus 1007 may be configured using a single bus or may be configured using different buses for each device.

The base station 10 and the terminal 20 may include hardware such as a microprocessor, a digital signal processor (DSP), an ASIC (Application Specific Integrated Circuit), a PLD (Programmable Logic Device), an FPGA (Field Programmable Gate Array), or the like, by which some or all of the functional blocks may be implemented. For example, the processor 1001 may be implemented using at least one of these types of hardware.

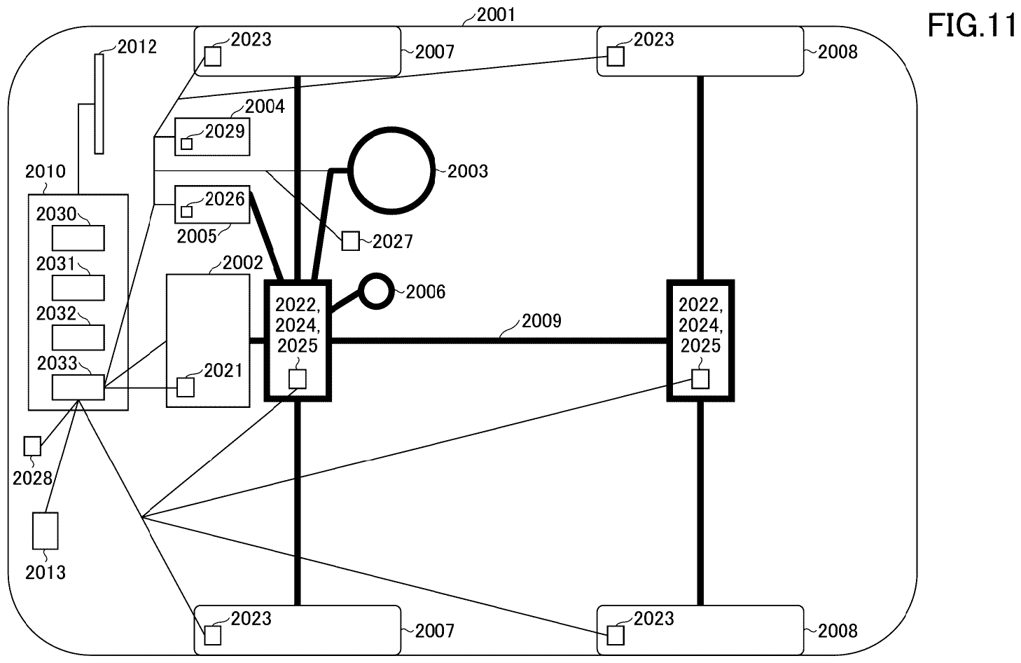

FIG. 11 shows an example of configuration of the vehicle 2001. As shown in FIG. 11, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic controller 2010, various sensors 2021-2029, an information service unit 2012, and a communication module 2013. Each aspect and embodiment described in the present disclosure may be applied to a communication device mounted on the vehicle 2001, for example, the communication module 2013.

The drive unit 2002 includes, for example, an engine, a motor, or an engine and motor hybrid. The steering unit 2003 includes at least a steering wheel (also referred to as a driving wheel) and is configured to steer at least one of the front wheels and the rear wheels based on operation of the steering wheel operated by a user.

The electronic controller 2010 includes a microprocessor 2031, a memory (ROM, RAM) 2032, and a communication port (IO port) 2033. The electronic controller 2010 receives signals from various sensors 2021-2029 provided in the vehicle 2001. The electronic controller 2010 may be referred to as an ECU (Electronic Control Unit).

The signals from the various sensors 2021-2029 include a current signal from a current sensor 2021 for sensing the current of a motor, a rotational speed signal of a front wheel and a rear wheel acquired by a rotational speed sensor 2022, an air pressure signal of a front wheel and a rear wheel acquired by an air pressure sensor 2023, a vehicle speed signal acquired by a vehicle speed sensor 2024, an acceleration signal acquired by an acceleration sensor 2025, a depression amount signal of an accelerator pedal acquired by an accelerator pedal sensor 2029, a depression amount signal of a brake pedal acquired by a brake pedal sensor 2026, an operation signal of a shift lever acquired by a shift lever sensor 2027, and a detection signal for detecting an obstacle, a vehicle, a pedestrian or the like acquired by an object detection sensor 2028.

The information service unit 2012 includes various devices such as a car navigation system, an audio system, a speaker, a television, and a radio for providing (outputting) various kinds of information such as driving information, traffic information, entertainment information, and the like, and one or more ECUs for controlling these devices. The information service unit 2012 provides various kinds of multimedia information and multimedia services to the occupants of the vehicle 2001 by using information acquired from an external device via the communication module 2013 or the like.

The information service unit 2012 may include an input device (e.g., keyboard, mouse, microphone, switch, button, sensor, touch panel, etc.) for receiving input from the outside, or may include an output device (e.g., displays, speakers, LED lamps, touch panels, etc.) for performing output to the outside.

The driver support system unit 2030 is composed of various devices such as a millimeter wave radar, a LiDAR (Light Detection and Ranging), a camera, a positioning locator (e.g., GNSS, etc.), a map information (e.g., high-definition (HD) maps, autonomous vehicle (AV) maps, etc.), a gyro system (e.g., IMU (Inertial Measurement Unit), INS (Inertial Navigation System), etc.), an AI (Artificial Intelligence) chip, and an AI processor to provide functions to prevent accidents and reduce the driver's driving load, and one or more ECUs to control these devices. The driver support system unit 2030 transmits and receives various types of information via the communication module 2013 to achieve a driver support function or an automatic driving function.

The communication module 2013 can communicate with the microprocessor 2031 and the components of the vehicle 2001 via a communication port. For example, the communication module 2013 transmits and receives data to and from a drive unit 2002, a steering unit 2003, an accelerator pedal 2004, a brake pedal 2005, a shift lever 2006, front wheels 2007, rear wheels 2008, an axle 2009, a microprocessor 2031 in the electronic controller 2010, a memory (ROM, RAM) 2032, and a sensor 2021-29 provided in the vehicle 2001 via the communication port 2033.

The communication module 2013 is a communication device that can be controlled by the microprocessor 2031 in the electronic controller 2010 and can communicate with an external device. For example, it transmits and receives various kinds of information to and from an external device via wireless communication. The communication module 2013 can be either inside or outside the electronic controller 2010. The external device may be, for example, a base station, a mobile station, or the like.

The communication module 2013 may transmit at least one of signals from the above-described various sensors 2021-2029 inputted to the electronic controller 2010, information obtained based on the signals, and information based on an input from an external (user) obtained via the information service unit 2012 to the external device via wireless communication. The electronic controller 2010, the various sensors 2021-2029, the information service unit 2012, and the like may be referred to as input units that accept inputs. For example, the PUSCH transmitted by the communication module 2013 may include information based on the inputs.

The communication module 2013 receives various types of information (traffic information, traffic signal information, inter-vehicle information, etc.) transmitted from the external device and displays them on the information service unit 2012 provided in the vehicle 2001. The information service unit 2012 may be referred to as an output unit that outputs information (For example, based on PDSCH (or data or information decoded from PDSCH) received by the communication module 2013, information is output to a device such as a display or a speaker).

The communication module 2013 also stores various types of information received from the external device in the memory 2032 available by the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheels 2007, the rear wheels 2008, the axle 2009, the sensor 2021-2029, and the like provided in the vehicle 2001.

### Supplement to Embodiments

Although the embodiments of the present invention have been described above, the disclosed invention is not limited to such embodiments, and those skilled in the art will understand various variations, modifications, alternatives, substitutions, and the like. Although specific numerical examples have been used to facilitate understanding of the invention, these numerical values are merely examples and any suitable value may be used unless otherwise specified. The categorization of items in the above description is not essential to the present invention, and matters described in two or more items may be used in combination as necessary, and matters described in one item may be applied to matters described in another item (as long as they do not conflict). The boundaries of functional units or processing units in the functional block diagram do not necessarily correspond to boundaries of physical components. The operations of a plurality of functional units may be physically performed by a single component, or the operations of a single functional unit may be physically performed by a plurality of components. With respect to the processing procedures described in the embodiments, the order of processing may be interchanged as long as there is no conflict. For convenience of processing description, the base station 10 and the terminal 20 have been described using functional block diagrams, but such devices may be implemented in hardware, software, or a combination thereof. The software running on the processor of the base station 10 in accordance with an embodiment of the present invention and the software running on the processor of the terminal 20 in accordance with an embodiment of the present invention may be stored in random access memory (RAM), flash memory, read only memory (ROM), EPROM, EEPROM, registers, hard disk (HDD), removable disk, CD-ROM, database, server, or any other suitable storage medium, respectively.

The notification of information is not limited to the aspects and embodiments described in the present disclosure and may be performed using other methods. For example, the notification of information may be performed by physical layer signaling (e.g., DCI (Downlink Control Information), UCI (Uplink Control Information)), upper layer signaling (e.g., Radio Resource Control (RRC) signaling, Medium Access Control (MAC) signaling), broadcast information (MIB (Master Information Block), SIB (System Information Block)), other signals, or combinations thereof. The RRC signaling may also be referred to as an RRC message, and may be, for example, an RRC Connection Setup message, an RRC Connection Reconfiguration message, or the like.

Aspects and embodiments described in this disclosure may include, but are not limited to, systems utilizing LTE (Long Term Evolution), LTE-A (LTE-Advanced), SUPER 3G, IMT-Advanced, 4G (4th generation mobile communication system), 5G (5th generation mobile communication system), 6th generation mobile communication system (6G), xth generation mobile communication system (xG) (xG (x is, for example, an integer, a decimal)), FRA (Future Radio Access), NR (New Radio), New radio access (NX), Future generation radio access (FX), W-CDMA (registered trademark), GSM (registered trademark), CDMA2000, UMB (Ultra Mobile Broadband), IEEE 802.11 (Wi-Fi(registered trademark)), IEEE 802.16 (WiMAX (registered trademark)), IEEE 802.20, UWB (Ultra-WideBand), Bluetooth (registered trademark), other suitable systems, and extensions thereon, and may be applied to at least one of the modified, created, and defined next-generation systems. It may also be applied to a combination of systems (e.g., a combination of at least one of LTE and LTE-A and 5G, etc.).

The processing procedures, sequences, flowcharts, etc., of the aspects and embodiments described herein may be interchanged in order as long as there is no conflict. For example, the methods described in this disclosure present the elements of the various steps using an exemplary order and are not limited to the particular order presented.

The particular operations described herein as being performed by base station 10 may in some cases be performed by its upper node. It will be apparent that in a network of one or more network nodes having base station 10, the various operations performed for communication with terminal 20 may be performed by at least one of base station 10 and other network nodes (Examples include, but are not limited to, MME or S-GW.) other than base station 10. Although one other network node other than base station 10 is illustrated above, the other network nodes may be a combination (e.g., MME and S-GW) of a plurality of other network nodes.

The information, signals, etc. described in the present disclosure may be output from an upper layer (or lower layer) to a lower layer (or upper layer). The information may be input or output via a plurality of network nodes.

The input or output information may be stored in a specific location (e.g., memory) or managed using a management table. Information and the like input and output may be overwritten, updated, or appended. Information and the like output may be deleted. Information and the like input may be transmitted to other devices.

Decisions in the present disclosure may be made by a value represented by a single bit (0 or 1), a true or false value (Boolean: true or false), or a numerical comparison (e.g., comparison with a predetermined value).

Software, whether referred to as software, firmware, middleware, microcode, hardware description language, or by any other name, should be broadly interpreted to mean instructions, instruction sets, codes, code segments, program codes, programs, subprograms, software modules, applications, software applications, software packages, routines, subroutines, objects, executables, execution threads, procedures, functions, and the like.

Software, instructions, information, and the like may also be transmitted and received over a transmission medium. For example, when software is transmitted from a website, server, or other remote source using at least one of wired (coaxial cable, fiber-optic cable, twisted-pair, digital subscriber line (DSL), etc.) and wireless (infrared rays, microwaves, etc.) technologies, at least one of these wired and wireless technologies is included within the definition of a transmission medium.

Information, signals, and the like described in this disclosure may be represented using any of a variety of different techniques. For example, data, instructions, commands, information, signals, bits, symbols, chips, and the like that may be referred to throughout the above description may be represented by voltages, currents, electromagnetic waves, magnetic fields or magnetic particles, light fields or photons, or any combination thereof.

The terms described in this disclosure and those necessary to understand the disclosure may be replaced with terms having the same or similar meanings. For example, at least one of the channels and symbols may be a signal (signaling). The signal may also be a message. The component carrier (CC) may also be referred to as a carrier frequency, cell, frequency carrier, etc.

As used herein, the terms “system” and “network” are used interchangeably.

Also, the information, parameters, etc. described in the present disclosure may be expressed using absolute values, relative values from predetermined values, or other corresponding information. For example, wireless resources may be indicated by an index.

The names used for the parameters described above are not in any way limiting. Furthermore, formulas, etc. using these parameters may differ from those explicitly disclosed in the present disclosure. Since the various channels (e.g., PUCCH, PDCCH, etc.) and information elements can be identified by any suitable name, the various names assigned to these various channels and information elements are not in any way limiting.

In the present disclosure, terms such as “base station (BS)”, “wireless base station”, “base station”, “fixed station”, “NodeB”, “eNodeB (eNB)”, “gNodeB (gNB)”, “access point”, “transmission point”, “reception point”, “transmission and reception point”, “cell”, “sector”, “cell group”, “carrier”, “component carrier”, and the like may be used interchangeably. Base stations may also be referred to by terms such as macrocell, small cell, femtocell, picocell, and the like.

A base station may accommodate one or more (e.g., three) cells. When a base station accommodates multiple cells, the entire coverage area of the base station may be partitioned into a plurality of smaller areas, and each smaller area may also provide communication services by a base station subsystem (e.g., a small indoor Remote Radio Head (RRH)). The term “cell” or “sector” refers to a portion or the entire coverage area of at least one of the base stations and base station subsystem providing communication services in this coverage.

In this disclosure, the transmission of information by the base station to a terminal may be replaced as the instruction from the base station to the terminal for an information-based control or operation.

In this disclosure, terms such as “mobile station (MS)”, “user terminal”, “user equipment (UE)”, and “terminal” may be used interchangeably.

A mobile station may also be referred to by those skilled in the art as a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable term.

At least one of the base stations and the mobile station may be referred to as a transmitter, receiver, communication device, etc. At least one of the base stations and the mobile station may be a device mounted on a mobile body, a mobile body itself, etc. The mobile body is an object that can move at any speed. It also naturally includes a case where the mobile body is stopped. Such vehicles include, but are not limited to, vehicles, transport vehicles, automobiles, motorcycles, bicycles, connected cars, excavators, bulldozers, wheel loaders, dump trucks, forklifts, trains, buses, carriages, rickshaws, ships and other watercrafts, airplanes, rockets, satellites, drones (registered trademark), multicopters, quadcopters, balloons, and objects mounted thereon. The mobile body may also be a mobile body that runs autonomously based on an operation command. It may be a vehicle (e.g., cars, airplanes, etc.), an unmanned mobile body (e.g., drones, self-driving cars, etc.), or a robot (manned or unmanned). Note that at least one of the base stations and the mobile station includes devices that do not necessarily move during communication operations. For example, at least one of the base stations and the mobile station may be an Internet of Things (IoT) device such as a sensor.

The base station in the present disclosure may be replaced with a user terminal. For example, each aspect and embodiment of the present disclosure may be applied to a configuration in which communication between the base station and the user terminal is replaced with communication between a plurality of terminals 20 (for example, it may be referred to as Device-to-Device (D2D) or Vehicle-to-Everything (V2X)). In this case, a configuration in which the terminal 20 has the function of the above-described base station 10 may be adopted. Further, words such as “up” and “down” may be replaced with words (e.g., “side”) corresponding to communication between terminals. For example, an uplink channel, a downlink channel, and the like may be replaced with a side channel.

Similarly, a user terminal in the present disclosure may be replaced with a base station. In this case, a configuration in which the base station has the functions of the user terminal described above may be adopted.

The term “determining” as used in the present disclosure may encompass a wide variety of actions. The terms “determining” may include considering that judging, calculating, computing, processing, deriving, investigating, looking up (search, inquiry) (e.g., searching in a table, database or another data structure), and ascertaining have performed to be “determined”. Moreover, “determining” may include considering that receiving (e.g., receiving information), transmitting (e.g., transmitting information), input, output, and accessing (e.g., accessing data in memory) have performed to be “determined” or “determined”. Moreover, “determining” may include considering that resolving, selecting, choosing, establishing, and comparing have performed to be “determined” or “determined”. That is, “determining” may include considering that some action is “determined” or “determined”. Also, “determining” may be replaced with “assuming”, “expecting”, “considering”, and the like.

The term “connected”, “coupled”, or any variation thereof, means any direct or indirect connection or connection between two or more elements, and may include the presence of one or more intermediate elements between two elements that are “connected” or “coupled” to each other. The connection or connection between the elements may be physical, logical, or a combination thereof. For example, “connect” may be replaced with “access”. As used in the present disclosure, two elements may be considered to be “connected” or “coupled” to each other using at least one of one or more wires, cables, and printed electrical connections, and by some non-limiting and non-exclusive examples, electromagnetic energy having wavelengths in the wireless frequency domain, microwave domain, and optical (both visible and invisible) domain, etc.

The reference signal may also be abbreviated as RS (Reference Signal) and may be referred to as a Pilot depending on the applicable standard.

In the present disclosure, the term “based on” does not mean “based only” unless otherwise specified. In other words, “based on” means both “based only” and “based at least on”.

Any reference to elements using designations such as “first”, “second”, etc. as used in the present disclosure does not generally limit the amount or order of those elements. These designations may be used in the present disclosure as a convenient way to distinguish between two or more elements. Thus, references to the first and second elements do not mean that only two elements may be employed or that in any way the first element must precede the second element.

The term “means” in the foregoing configurations of devices may be replaced with “units”, “circuits”, “devices”, and the like.

Where “include”, “including”, and variations thereof are used in the present disclosure, these terms are intended to be inclusive, as is the term “comprising”. Furthermore, the term “or” as used in the present disclosure is intended not to be exclusive-OR.

A wireless frame may include one or more frames in the time domain. Each one or more frames in the time domain may be referred to as a subframe. The subframe may also include one or more slots in the time domain. The subframe may have a fixed time length (e.g., 1 ms) independent of numerology.

A numerology may be a communication parameter applied to at least one of transmission and reception of a signal or channel. The numerology may indicate at least one of, for example, subcarrier spacing (SCS), bandwidth, symbol length, cyclic prefix length, transmission time interval (TTI), number of symbols per TTI, wireless frame configuration, a particular filtering operation performed by the transceiver in the frequency domain, a particular windowing operation performed by the transmitter and receiver in the time domain, and the like.

The slot may consist of one or more symbols (OFDM (Orthogonal Frequency Division Multiplexing) symbols, SC-FDMA (Single Carrier Frequency Division Multiple Access) symbols, etc.) in the time domain. The slot may be a time unit based on numerology.

The slot may include a plurality of minislots. Each minislot may consist of one or more symbols in the time domain. The minislot may also be referred to as a subslot. The minislot may consist of fewer symbols than the slot. PDSCH (or PUSCH) transmitted in time units larger than the minislot may be referred to as PDSCH (or PUSCH) Mapping Type A. PDSCH (or PUSCH) transmitted using the minislot may be referred to as PDSCH (or PUSCH) Mapping Type B.

The wireless frame, the subframe, the slot, the minislot, and the symbol all represent time units in transmitting signals. The wireless frame, the subframe, the slot, the minislot, and the symbol may be referred to as different names corresponding to them.

For example, one subframe may be referred to as a transmission time interval (TTI), a plurality of consecutive subframes may be referred to as the TTI, and one slot or one minislot may be referred to as the TTI. That is, at least one of the subframe and the TTI may be the subframe (1 ms) in existing LTE, a period shorter than 1 ms (e.g., 1-13 symbols), or a period longer than 1 ms. Note that the unit representing TTI may be referred to as the slot, the minislot, or the like instead of the subframe.

Here, TTI means, for example, a minimum time unit for scheduling in wireless communication. For example, in an LTE system, the base station performs scheduling to allocate wireless resources (frequency bandwidth, transmission power, etc., that can be used by each terminal 20) to each terminal 20 in TTI units. The definition of TTI is not limited to this.

The TTI may be a transmission time unit for channel-encoded data packets (transport blocks), code blocks, code words, or the like, or it may be a processing unit for scheduling, link adaptation, or the like. When TTI is given, a time interval (e.g., the number of symbols) in which the transport blocks, code blocks, code words, or the like are actually mapped may be shorter than the TTI.

When one slot or one minislot is referred to as TTI, one or more TTIs (i.e., one or more slots or one or more minislots) may be the minimum time unit for scheduling. The number of the slots (number of the minislots) constituting the minimum time unit for scheduling may be controlled.

A TTI having a time length of 1 ms may be referred to as a normal TTI (TTI in LTE Rel. 8-12), a normal TTI, a long TTI, a normal subframe, a normal subframe, a long subframe, a slot, or the like. A TTI shorter than the normal TTI may be referred to as a shortened TTI, a short TTI, a partial TTI (partial or fractional TTI), a shortened subframe, a short subframe, a minislot, a subslot, a slot, or the like.

The long TTI (e.g., normal TTI, subframe, etc.) may be replaced with a TTI having a time length over 1 ms, and the short TTI (e.g., shortened TTI, etc.) may be replaced with a TTI having a TTI length less than the TTI length of the long TTI and over or equal to 1 ms.

A resource block (RB) is a resource allocation unit in the time domain and the frequency domain, and may include one or more consecutive subcarriers in the frequency domain. The number of subcarriers included in the RB may be the same regardless of the numerology, for example, 12. The number of subcarriers included in an RB may be determined based on the numerology.

The time domain of the RB may include one or more symbols, and may have a length of one slot, one minislot, one subframe, or one TTI. Each one TTI, one subframe, or the like may consist of one or more resource blocks.

The one or more RBs may be referred to as a physical resource block (PRB), a sub-carrier group (SCG), a resource element group (REG), a PRB pair, an RB pair, or the like.

The resource block may consist of one or more resource elements (RE). For example, 1 RE may consist of one sub-carrier and one symbol wireless resource area.

The bandwidth part (BWP) (may be referred to as a partial bandwidth, etc.) may represent a subset of consecutive common resource blocks (RBs) for a certain numerology in a certain carrier. Here, the common RB may be specified by an index of RBs with reference to a common reference point of the carrier. A PRB may be defined in a BWP and numbered within the BWP.

The BWP may include a BWP for UL (UL BWP) and a BWP for DL (DL BWP). One or more BWPs may be configured within a carrier for the terminal 20.

At least one of the configured BWPs may be active, and the terminal 20 need not assume to transmit or receive a predetermined signal or channel outside of the active BWP. The terms “cell” and “carrier” in the present disclosure may be replaced with “BWP”.

The structures of wireless frames, subframes, slots, minislots, symbols, and the like described above are exemplary only. For example, the number of subframes included in a wireless frame, the number of subframes or slots per wireless frame, the number of minislots included in a slot, the number of symbols and RBs included in a slot or minislot, the number of subcarriers included in an RB, and the number of symbols, symbol lengths, and cyclic prefix (CP) lengths in a TTI may be varied.

In the present disclosure, when articles are added by translation, for example, a, an, and the in English, the present disclosure may include that the nouns following these articles are plural.

In the present disclosure, the term “A and B are different” may mean “A and B are different from each other”. The term may mean “A and B are different from C, respectively”. Terms such as “separate” and “combined” may also be interpreted as “different”.

Each of the aspects and embodiments described in the present disclosure may be used alone, in combination, or switched with the implementation. The notification of predetermined information (e.g., “X” notification) is not limited to an explicit one, but may be performed implicitly (e.g., no notification of the prescribed information).

Although the present disclosure has been described in detail above, it will be apparent to those skilled in the art that the present disclosure is not limited to the embodiments described in the present disclosure. the present invention is not limited to these embodiments, but various variations and modifications may be made without departing from the scope of the present invention. Accordingly, the description of the present disclosure is for illustrative purposes only and does not have any restrictive meaning to the present disclosure.

### DESCRIPTION OF CODES

10 base station
110 transmitting unit
120 receiving unit
130 configuration unit
140 controller
20 terminal
210 transmitting unit
220 receiving unit
230 configuration unit
240 controller
1001 processor
1002 storage device
1003 auxiliary storage device
1004 communication device
1005 input device
1006 output device
2001 vehicle
2002 drive unit
2003 steering unit
2004 accelerator pedal
2005 brake pedal
2006 shift lever
2007 front wheel
2008 rear wheel
2009 axle
2010 electronic controller
2012 information service unit
2013 communication module
2021 current sensor
2022 rotational speed sensor
2023 air pressure sensor
2024 vehicle speed sensor
2025 acceleration sensor
2026 brake pedal sensor
2027 shift lever sensor
2028 object detection sensor
2029 accelerator pedal sensor
2030 driver support system unit
2031 microprocessor
2032 memory (ROM, RAM)
2033 communication port (IO port)

1. A terminal comprising:
a receiving unit configured to receive a synchronization signal or a broadcast signal; and
a controller configured to assume that receiving the synchronization signal or the broadcast signal is based on individual configurations for a terminal with reduced functions.

2. The terminal according to claim 1, wherein the controller is configured to assume that the synchronization signal or the broadcast signal having a same index is received for a plurality of times.

3. The terminal according to claim 1, wherein the controller is configured to assume that a bandwidth of the synchronization signal or the broadcast signal exceeding a maximum bandwidth of the terminal with reduced functions has been punctured or assume that reception is performed by puncturing the bandwidth of the synchronization signal or the broadcast signal exceeding the maximum bandwidth of the terminal with reduced functions.

4. The terminal according to claim 1, wherein the controller is configured to assume that the synchronization signal or the broadcast signal is received at a time or frequency resource defined by the individual configurations.

5. A base station comprising:
a transmitting unit configured to transmit a synchronization signal or a broadcast signal to a terminal; and
a controller configured to assume that the synchronization signal or the broadcast signal is received based on individual configurations for a terminal with reduced functions.

6. A communication method performed by a terminal comprising:
receiving a synchronization signal or a broadcast signal; and
assuming that receiving the synchronization signal or the broadcast signal is based on individual configurations for a terminal with reduced functions.
